(19) United States
(12) Patent Application Publication
(10) Pub. No.: US 2010/0202311 A1
(43) Pub. Date: Aug. 12, 2010

(54) METHOD AND APPARATUS FOR PROVIDING CHANNEL STATE REPORTING

(75) Inventors: Timo Lunttila, Espoo (FI); Tommi Koivisto, Espoo (FI); Timo Roman, Espoo (FI)

Correspondence Address: DITTHAVONG MORI & STEINER, P.C., 918 Prince Street, Alexandria, VA, 22314, US

(73) Assignee: Nokia Siemens Networks Oy, Espoo (FI)

(21) Appl. No.: 12/702,543

(22) Filed: Feb. 9, 2010

Related U.S. Application Data
(60) Provisional application No. 61/150,861, filed on Feb. 9, 2009.

(51) Int. Cl. H04L 12/26

(52) U.S. Cl. 370/252

(57) ABSTRACT

An approach is provided for optimizing the timing scheme for channel state reporting. A platform determines an offset value for each of a plurality of user equipment. The offset value relates to timing between a channel state measurement point and a corresponding point for reporting of the channel state measurement. The platform further initiates signaling of the offset values to the respective user equipment.

### BACKGROUND

Radio communication systems, such as wireless data networks (e.g., Third Generation Partnership Project (3GPP) Long Term Evolution (LTE) systems, spread spectrum systems (such as Code Division Multiple Access (CDMA) networks), Time Division Multiple Access (TDMA) networks, WiMAX (Worldwide Interoperability for Microwave Access), etc.), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One area of effort involves measurement and reporting of channel state information, which permits optimization of transmission parameters, such as power requirements, bandwidth allocation, modulation schemes, etc. Traditionally, such channel state information has been reported using timing schemes that cause excessive loads on certain system resources while leaving other resources unused.

### SOME EXAMPLE EMBODIMENTS

Therefore, there is a need for an approach for optimizing the timing scheme for channel state reporting.

According to one embodiment, a method comprises determining an offset value for each of a plurality of user equipment. The offset value relates to timing between a channel state measurement point and a corresponding point for reporting of the channel state measurement. The method also comprises initiating signaling of the offset values to the respective user equipment.

According to another embodiment, a computer-readable storage medium carries one or more sequences of one or more instructions which, when executed by one or more processors, cause an apparatus to at least determine an offset value for each of a plurality of user equipment. The offset value relates to timing between a channel state measurement point and a corresponding point for reporting of the channel state measurement. The apparatus is further caused to initiate signaling of the offset values to the respective user equipment.

According to another embodiment, an apparatus comprises at least one processor, and at least one memory including computer program code, the at least one memory and the computer program code configured to, with the at least one processor, cause, at least in part, the apparatus to determine an offset value for each of a plurality of user equipment. The offset value relates to timing between a channel state measurement point and a corresponding point for reporting of the channel state measurement. The apparatus is further caused to initiate signaling of the offset values to the respective user equipment.

According to another embodiment, an apparatus comprises means for determining an offset value for each of a plurality of user equipment. The offset value relates to timing between a channel state measurement point and a corresponding point for reporting of the channel state measurement. The apparatus further comprises means for initiating signaling of the offset values to the respective user equipment.

According to one embodiment, a method comprises receiving an offset value that relates to timing between a channel state measurement point and a corresponding point for reporting of the channel state measurement. The method also comprises initiating a measurement procedure for determining channel state parameters. The method further comprises generating a measurement report, specifying the channel state parameters, for transmission to one or more base stations over different subframes of a common transmission frame.

According to another embodiment, a computer-readable storage medium carries one or more sequences of one or more instructions which, when executed by one or more processors, cause an apparatus to at least receive an offset value that relates to timing between a channel state measurement point and a corresponding point for reporting of the channel state measurement. The apparatus is also caused to initiate a measurement procedure for determining channel state parameters. The apparatus is further caused to generate a measurement report, specifying the channel state parameters, for transmission to one or more base stations over different subframes of a common transmission frame.

According to another embodiment, an apparatus comprises at least one processor, and at least one memory including computer program code, the at least one memory and the computer program code configured to, with the at least one processor, cause, at least in part, the apparatus to receive an offset value that relates to timing between a channel state measurement point and a corresponding point for reporting of the channel state measurement. The apparatus is also caused to initiate a measurement procedure for determining channel state parameters. The apparatus is further caused to generate a measurement report, specifying the channel state parameters, for transmission to one or more base stations over different subframes of a common transmission frame.

According to another embodiment, an apparatus comprises means for receiving an offset value that relates to timing between a channel state measurement point and a corresponding point for reporting of the channel state measurement. The apparatus also comprises means for initiating a measurement procedure for determining channel state parameters. The apparatus further comprises means for generating a measurement report, specifying the channel state parameters, for transmission to one or more base stations over different subframes of a common transmission frame.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a communication system capable of providing a channel state reporting scheme, according to an exemplary embodiment;

FIG. 2 is a diagram of a traditional timing pattern for a channel state reporting scheme, according to an exemplary embodiment;

FIG. 3 is a flowchart of a process for providing optimized timing for a channel state reporting scheme, according to an exemplary embodiment;

FIGS. 4A-4C are diagrams of optimized timing patterns for an aperiodic channel state reporting scheme, according to various exemplary embodiments;

FIGS. 5A and 5B are diagrams of optimized timing patterns for periodic channel state reporting scheme, according to various exemplary embodiments;

FIGS. 6A-6D are diagrams of communication systems having exemplary long-term evolution (LTE) architectures, in which the user equipment (UE) and the base station of FIG. 1 can operate, according to various exemplary embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile station (e.g., handset) that can be used to implement an embodiment of the invention.

### DESCRIPTION OF SOME EMBODIMENTS

An apparatus, method, and software for providing channel state reporting are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a wireless network compliant with the Third Generation Partnership Project (3GPP) Long Term Evolution (LTE) architecture, it is recognized by one of ordinary skill in the art that the embodiments of the inventions have applicability to any type of communication system and equivalent functional capabilities. It also contemplated that channel state reporting includes, for example, reporting of a channel quality indicator (CQI), precoding matrix indicator (PMI), rank indicator (RI), complex channel frequency response, channel impulse response, other like indicators, and/or any combination thereof.

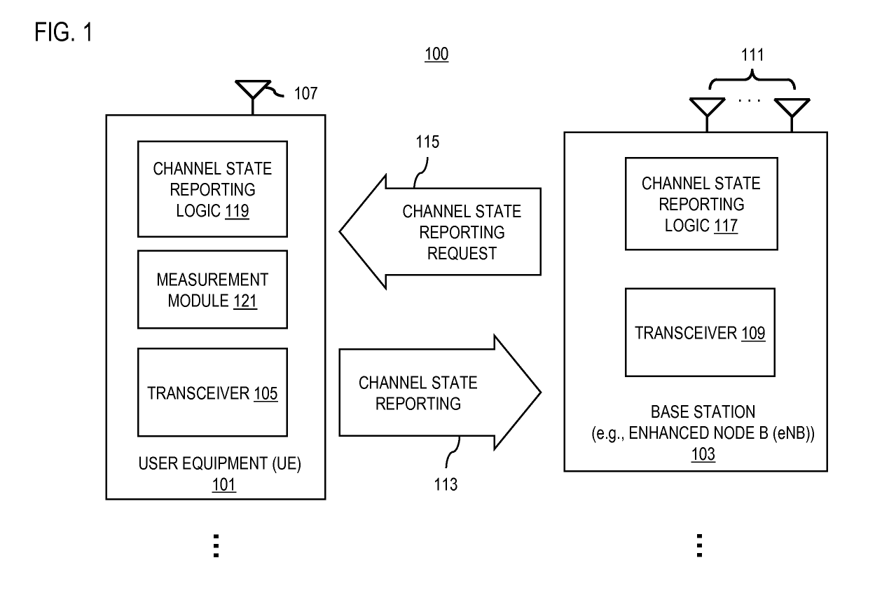

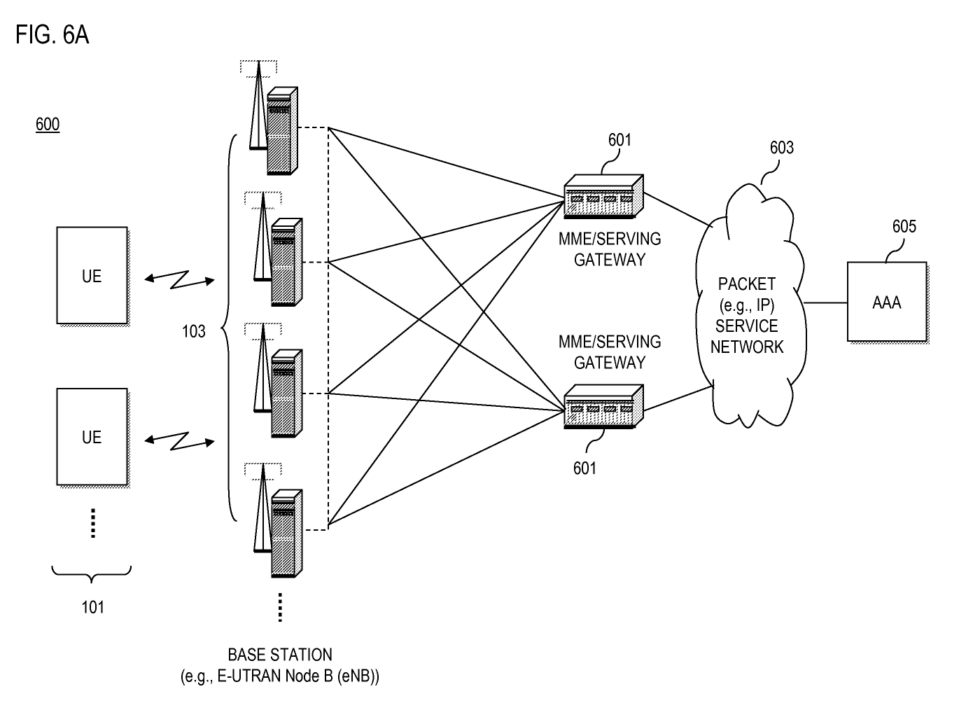

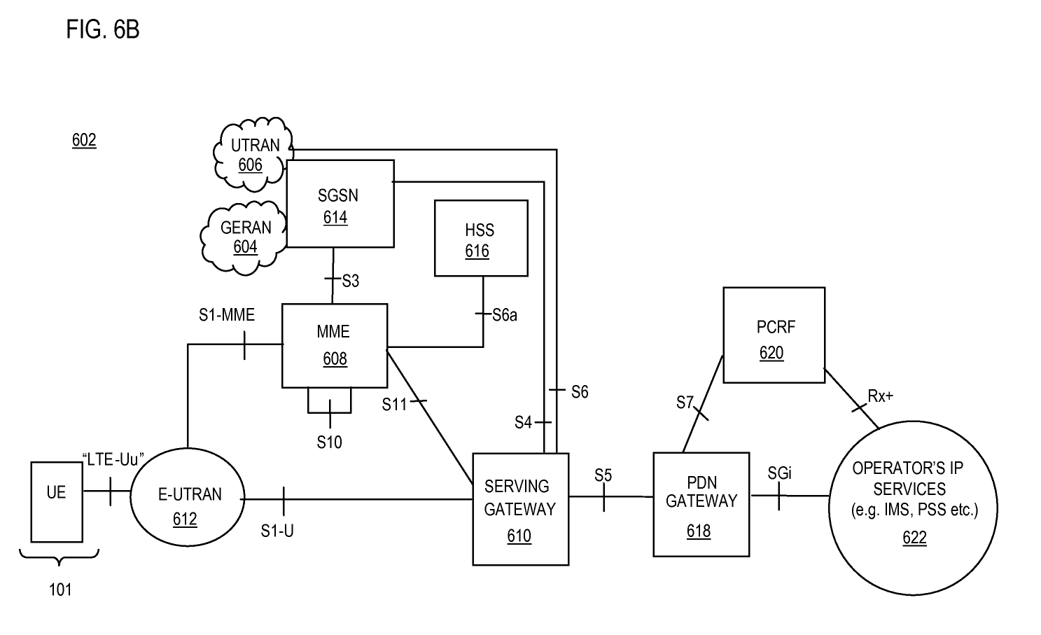

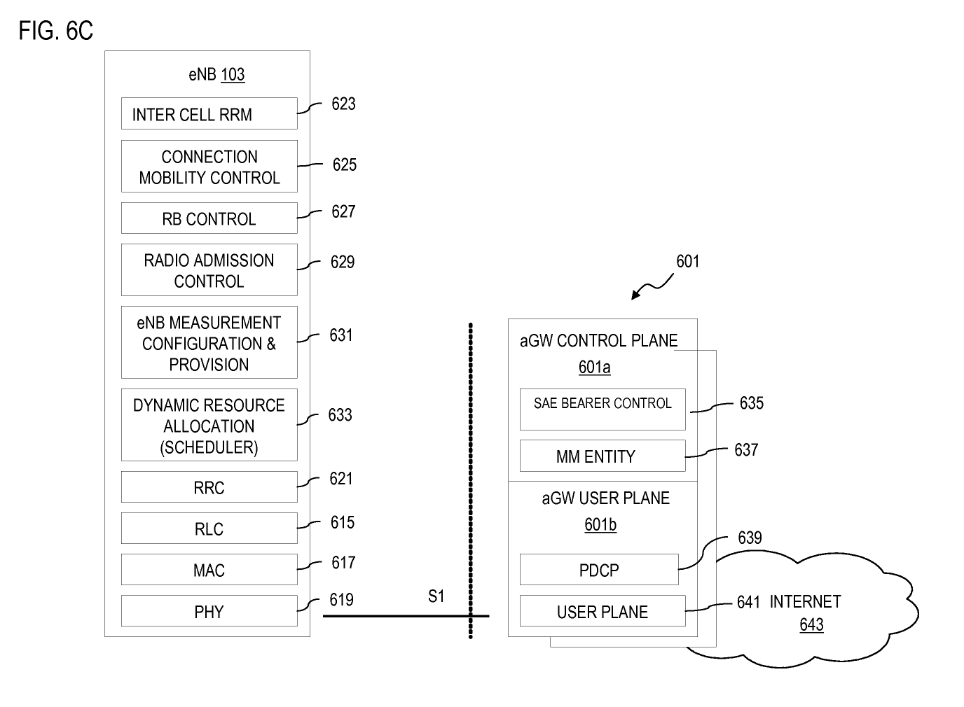

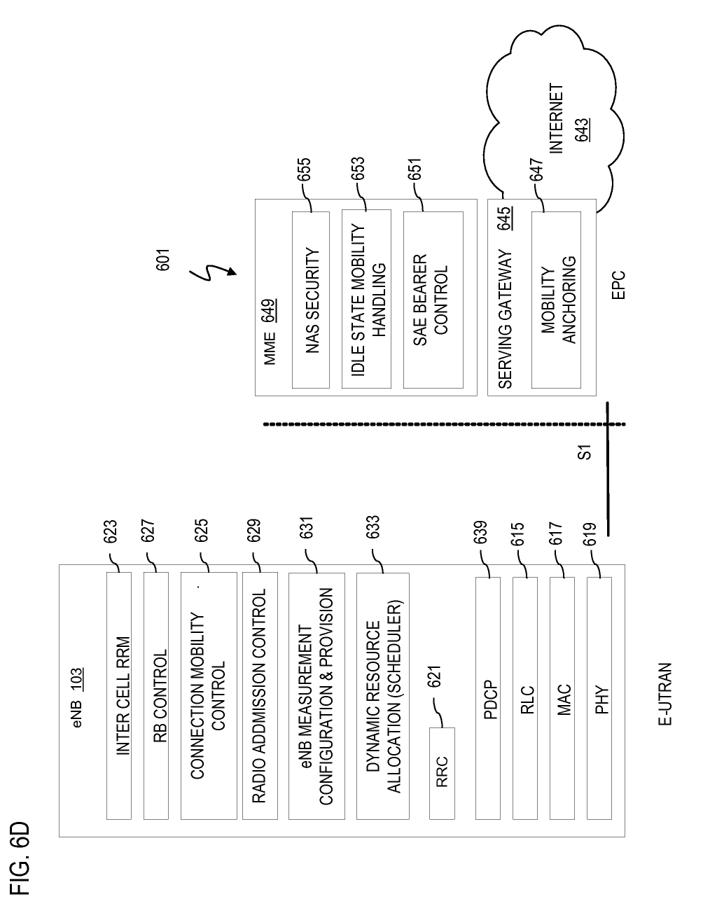

FIG. 1 is a diagram of a communication system capable of providing a channel state reporting scheme, according to an exemplary embodiment. As shown in FIG. 1, a communication system 100 includes one or more user equipment (UEs) 101 communicating with one or more base stations 103, which are part of an access network (e.g., 3GPP LTE or E-UTRAN, etc.). In exemplary embodiments, it is contemplated that the UE 101 may perform channel state measurements and transmit the corresponding channel state report to a single serving base station 103 or to multiple serving stations that are seen by the UE 101 individually or as a whole (e.g., as a super-cell). Under the 3GPP LTE architecture (as shown in FIGS. 6A-6D), the base station 103 is denoted as an enhanced Node B (eNB). The UE 101 can be any type of mobile stations, such as handsets, terminals, stations, units, devices, multimedia tablets, Internet nodes, communicators, Personal Digital Assistants (PDAs) or any type of interface to the user (such as “wearable” circuitry, etc.). The UE 101 includes a transceiver 105 and an antenna system 107 that couples to the transceiver 105 to receive or transmit signals from the base station 103. The antenna system 107 can include one or more antennas. For the purposes of illustration, the time division duplex (TDD) mode of 3GPP is described herein; however, it is recognized that other modes can be supported, e.g., frequency division duplex (FDD).

As with the UE 101, the base station 103 employs a transceiver 109, which transmits information to the UE 101. Also, the base station 103 can employ one or more antennas 111 for transmitting and receiving electromagnetic signals. For instance, the eNB may utilize a Multiple Input Multiple Output (MIMO) antenna system, whereby the eNB 103 can support multiple antenna transmit and receive capabilities. This arrangement can support the parallel transmission of independent data streams to achieve high data rates between the UE 101 and eNB 103. The base station 103, in an exemplary embodiment, uses OFDM (Orthogonal Frequency Divisional Multiplexing) as a downlink (DL) transmission scheme and a single-carrier transmission (e.g., SC-FDMA (Single Carrier-Frequency Division Multiple Access)) with cyclic prefix for the uplink (UL) transmission scheme.

It is noted that there is a growing trend towards transmission schemes that rely on greater numbers of transmission antennas. For example, the LTE architecture (e.g., LTE-Advanced) enables the eNB 103 to support up to eight transmission antennas 111 and up to 8×8 downlink spatial multiplexing (i.e., downlink data transmission with 8 parallel spatial streams). Accordingly, the UE 101 may have to perform channel state reporting 113 and/or channel state measurements from up to eight transmission antennas 111 at the base station 103, leading to the potential for greater transmission overhead. In one embodiment, the channel state reporting 113 may be initiated, at least in part, by a channel state reporting request 115 transmitted by the channel state reporting logic 117 of the base station 103. The request 115 can be received by a channel state reporting logic 119 of the UE 101 which interacts with a measurement module 121 to collect channel state information and prepare the measurement report. For instance, LTE defines common reference symbols (CRSs) that are transmitted in every DL subframe and represent a significant amount of total DL overhead (e.g., up to 14.3% of the total DL overhead). With eight antennas 111, the overhead may approach 30%. To reduce potential overhead, it is noted that LTE-Advanced provides for reducing the number of periodic CRSs and channel state reports (e.g., instead of every DL subframe, the CRS is transmitted every N subframes where N is a configurable number). For example, LTE-Advanced defines additional types of reference symbols (RSs): a channel quality indicator reference symbol (CQI-RS) or a channel state indicator reference symbol (CSI-RS) for channel state (e.g., CQI, PMI, RI, channel frequency response, channel impulse response) reporting which is transmitted when needed, and a data demodulation RS for demodulation of the physical downlink shared channel (PDSCH). Hence, under LTE-Advanced, the CRS for channel state measurements will likely be transmitted with a periodicity larger than the traditional 1-ms time interval used for channel state measurements and data demodulation). The use of transmission protocols such as cooperative multiple input multiple out (MIMO)/multipoint transmission (CoMP) may also increase transmission overhead.

However, having the CRS for an eNB 103 with multiple transmission antennas 111 (e.g., eight antennas (8-TX)) or using CoMP in only a subset of all subframes has significant implications on channel state measurement and reporting. Under this scenario, all UEs (such as UE 101) perform channel state measurement and reporting on some of the multi-antenna or CoMP subframes using a defined periodicity (e.g., every N subframes). In such a case, having a fixed timing relationship between the channel state measurement and the corresponding transmission of the channel state report in the UL means that the load of the UL channel carrying the reports (e.g., primarily the physical uplink control channel (PUCCH), but also the physical uplink shared channel (PUSCH)) would be very high in the UL subframes used for reporting channel state. On the other hand, the load on other subframes from channel state reporting would be zero. The disparity in loads between different subframes is problematic particularly when the size of channel state reports for eNBs 103 with more antennas is likely to be somewhat larger than similar reports for eNBs 103 with fewer antennas 111.

In addition, for aperiodic channel state reporting, the UL grants carrying the bit to trigger channel state reporting (e.g., the channel state reporting request 115) is transmitted in same subframe (e.g., the measurement subframe) under current LTE architecture. As a result, all UEs (such as UE 101) would have the same channel state reporting trigger instance in the DL and correspondingly the same channel state reporting 113 instances in the UL, resulting in overload of both the downlink channels (e.g., the physical downlink control channel (PDCCH) used for UL grants) and the uplink channels (e.g., PUCCH and PUSCH used for reporting). To address this problem, the approach described herein optimizes the timing of both periodic and aperiodic channel state reporting schemes to more evenly distribute the load within the UL and DL channels.

Typically, the base station 103 and UE 101 regularly exchange control information. Such control information, in an exemplary embodiment, is transported over a control channel on, for example, the downlink from the base station 103 to the UE 101. By way of example, a number of communication channels are defined for use in the system 100 of FIG. 1. The channel types include: physical channels, transport channels, and logical channels. For instance in LTE system, the physical channels include, among others, a Physical Downlink Shared channel (PDSCH), Physical Downlink Control Channel (PDCCH), Physical Uplink Shared Channel (PUSCH), and Physical Uplink Control Channel (PUCCH). The transport channels can be defined by how they transfer data over the radio interface and the characteristics of the data. In LTE downlink, the transport channels include, among others, a broadcast channel (BCH), paging channel (PCH), and Down Link Shared Channel (DL-SCH). In LTE uplink, the exemplary transport channels are a Random Access Channel (RACH) and UpLink Shared Channel (UL-SCH). Each transport channel is mapped to one or more physical channels according to its physical characteristics.

Each logical channel can be defined by the type and required Quality of Service (QoS) of information that it carries. In LTE system, the associated logical channels include, for example, a broadcast control channel (BCCH), a paging control channel (PCCH), Dedicated Control Channel (DCCH), Common Control Channel (CCCH), Dedicated Traffic Channel (DTCH), etc.

In LTE system, the BCCH (Broadcast Control Channel) can be mapped onto both BCH and DL-SCH. As such, this is mapped to the PDSCH; the time-frequency resource can be dynamically allocated by using L1/L2 control channel (PDCCH). In this case, BCCH (Broadcast Control Channel)-RNTI (Radio Network Temporary Identifier) is used to identify the resource allocation information.

To ensure accurate delivery of information between the eNB 103 and the UE 101, the system 100 of FIG. 1 utilizes error detection in exchanging information, e.g., Hybrid ARQ (HARQ). HARQ is a concatenation of Forward Error Correction (FEC) coding and an Automatic Repeat Request (ARQ) protocol. Automatic Repeat Request (ARQ) is an error recovery mechanism used on the link layer. As such, this error recovery scheme is used in conjunction with error detection schemes (e.g., CRC (cyclic redundancy check)), and is handled with the assistance of error detection modules and within the eNB 103 and UE 101, respectively. The HARQ mechanism permits the receiver (e.g., UE 101) to indicate to the transmitter (e.g., eNB 103) that a packet or sub-packet has been received incorrectly, and thus, requests the transmitter to resend the particular packet(s).

In LTE, channel state reporting (e.g., CQI, PMI, RI, channel frequency response, channel impulse response) can be either periodic or aperiodic. The baseline mode for channel state reporting is periodic reporting using a physical uplink control channel (PUCCH). The eNB 103 configures the periodicity parameters and the PUCCH resources via higher layer signaling. The size of a single channel state report is limited to about 11 bits depending on the reporting mode. Generally, the channel state reports contain little or no information about the frequency domain behavior of the propagation channel. Periodic reports are normally transmitted on the PUCCH. However, if the UE 101 is scheduled data in the UL, the periodic channel state report moves to the physical uplink shared channel (PUSCH). The reporting period of the RI is a multiple of the CQI/PMI reporting periodicity. RI reports use the same PUCCH resource (e.g., physical resource block (PRB), cyclic shift) as the CQI/PMI reports (e.g., PUCCH format 2/2a/2b or alternatively PUSCH).

In addition to periodic channel state reporting, LTE also enables the eNB 103 to request the UE 101 to perform aperiodic reporting. For example, the eNB 103 can trigger the UE 101 to send an aperiodic channel state report in any subframe of radio transmission frame except for subframes in which the UE 101 is configured for discontinuous reception/discontinuous transmission (DRX/TRX). The eNB 103 triggers an aperiodic channel state report by using, for instance, one specific bit in the UL grant (e.g., transmitted on the PDCCH). The eNB 103 also may request the UE 101 transmit the aperiodic channel state report without a simultaneous UL data transmission (e.g., an aperiodic CQI only report). In LTE, there are multiple methods for aperiodic channel state reporting. Each UE 101 is configured via, for instance, radio resource control (RRC) signaling to operate in one aperiodic reporting mode. Typically, a UE 101 operates in a default aperiodic reporting mode depending on the transmission mode until the UE 101 is explicitly configured to operate in another mode.

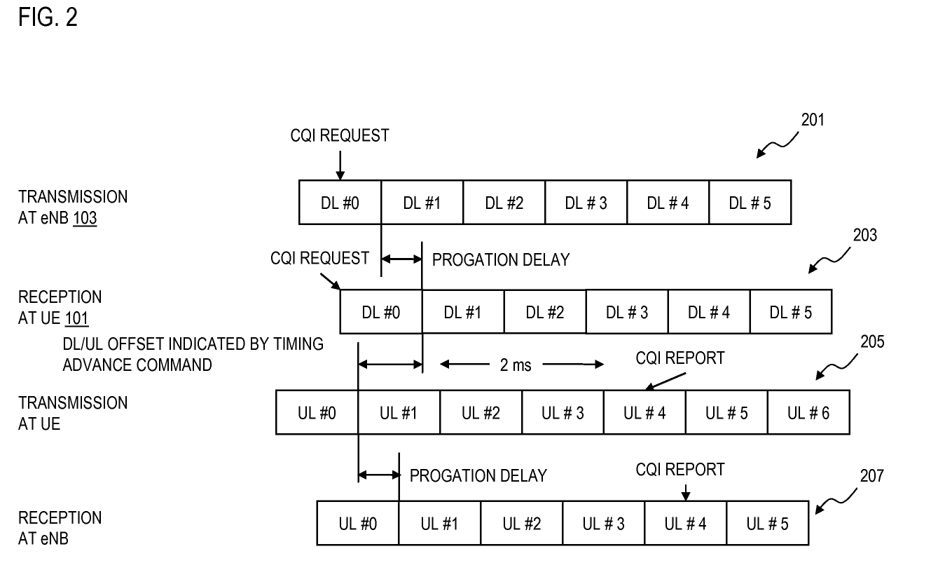

FIG. 2 is a diagram of a traditional timing pattern for a channel state reporting scheme, according to an exemplary embodiment. To generate a channel state report, the UE 101 (e.g., using the measurement module 121) first performs a measurement of, for instance, the instantaneous channel quality, preferred rank, and corresponding precoding matrix. In LTE, the channel state report of these measurements is transmitted in the UL subframe n as shown in FIG. 2. By way of example, the DL subframe where the channel state measurements (e.g., CQI, PMI, RI, channel frequency response, channel impulse response) are performed is the DL subframe n−4 or the last DL subframe before subframe n−4 if the sub frame n−4 corresponds to an UL subframe. In FIG. 2, the bit for triggering channel state reporting is transmitted in subframe n−4 when initiating aperiodic reporting. In response, the UE 101 performs the channel state measure in subframe n−4 and transmits the corresponding channel state report in UL subframe n.

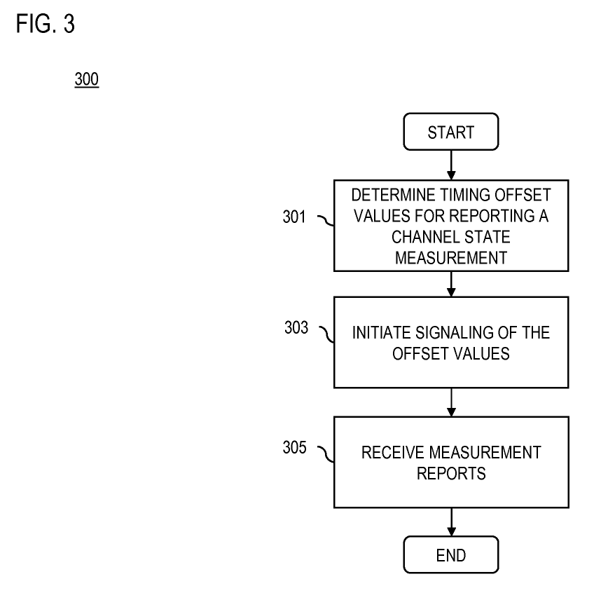

FIG. 3 is a flowchart of a process for providing optimized timing for a channel state reporting scheme, according to an embodiment. The process 300 of FIG. 3 defines the timing relationships and related signaling to support channel state (e.g., CQI, PMI, RI, channel frequency response, channel impulse response) reporting when only a subset of all subframes can be utilized for the channel state measurement. The proposed timing mechanisms avoid the problems of having all channel state reports transmitted in the same UL subframe, and also addresses the problem of having the channel state reporting triggers overload the DL channels (e.g., the PDCCH).

In step 301, the system 100 of FIG. 1 (e.g., using the channel state reporting logics 117 and/or 119) determines the timing offset value for each of a plurality of UEs 101. Each offset value relates to the timing between a channel state measurement point and a corresponding point for reporting of the channel state measurement. In step 303, process 300 initiates signaling of the offset values to the respective user equipment 101.

In one embodiment, a fixed timing offset (e.g., 4, 5, 6, etc. subframes) between the channel state measurement and the corresponding report of the measurement is defined per UE 101. The per-UE offset enables for easy multiplexing of different UE 101 on to the control resource on the PUCCH or the PUSCH. The offset could be signaled along with other channel state related parameters via higher layers (e.g., dedicated radio resource control (RRC) signaling). Alternatively, the offset could be defined implicitly based on, for instance, a UE identification number, PUCCH resource index, PUSCH physical resource block allocation, or some other similar parameter.

In certain embodiments, UEs 101 are grouped from high to low velocities before assigning a particular offset. It is noted that UEs 101 with larger offset values have corresponding larger latencies. This latency can be problematic for UEs 101 at high velocity because the channel state reports for high velocity UEs 101 expire more quickly. After grouping the UEs 101 based on velocity, UEs 101 with higher velocities are assigned lower value offsets.

In another embodiment, varying time offsets between the channel state measurement and the corresponding report is assigned per UE 101. The offset could vary deterministically based on some predefined pattern, or the offset value could be obtained implicitly based on, for instance, the modulo operation on the subframe number and/or some other parameter. Under this approach, the channel state reporting delay for each UE 101 becomes random or pseudo-random, and the potential degradation due to increased reporting latency is effectively averaged at a system level. At the same time, the approach distributes the uplink reporting load over multiple uplink subframes.

In another embodiment, when applied to aperiodic channel state reporting, the channel state measurement and reporting time is separated from the UL HARQ timing. In addition, the reference period of the measurement (i.e., the DL subframe used for the channel state measurement) can be later than the subframe where the channel state reporting trigger bit is received. For example, for a UE 101 configured in transmission mode, the measurement subframe for the aperiodic channel state report received in the DL subframe n is the next available valid DL subframe where the measurement subframe (subframe m) is greater than or equal to the subframe in which the trigger is received (subframe n). Furthermore, the channel state report would then be transmitted either in the UL subframe M+4, or later. This way, the eNB 103 may avoid the excessive loading of DL subframes with aperiodic channel state reporting requests.

In another embodiment, the timing offset is explicitly signaled to the UE 101 dynamically using the same DL assignment. The signal includes the aperiodic trigger with additional bits for the timing offset. The signaling may also be implicit (e.g., tied to some other PDCCH field), in which case additional signaling overhead would not occur. Furthermore, the timing of the UL signaling can be tied to the time instance of the reception of the aperiodic channel state reporting trigger in the DL.

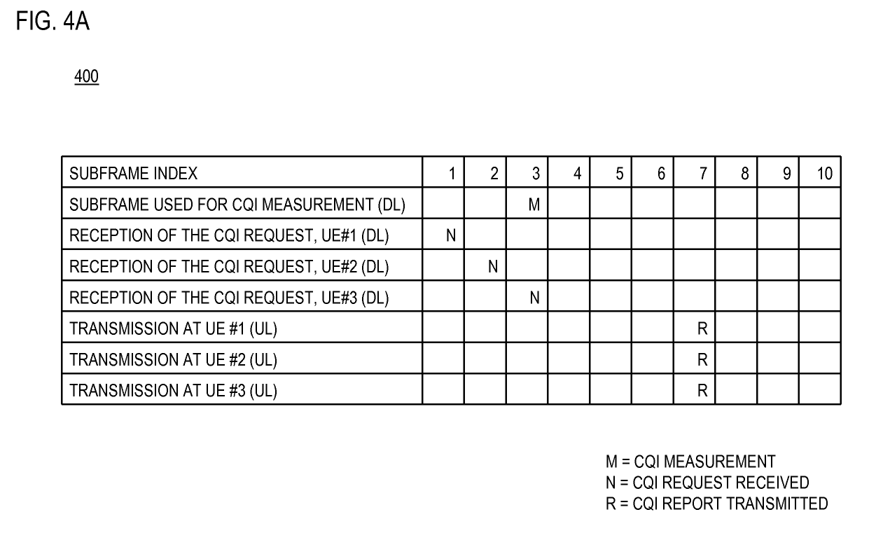

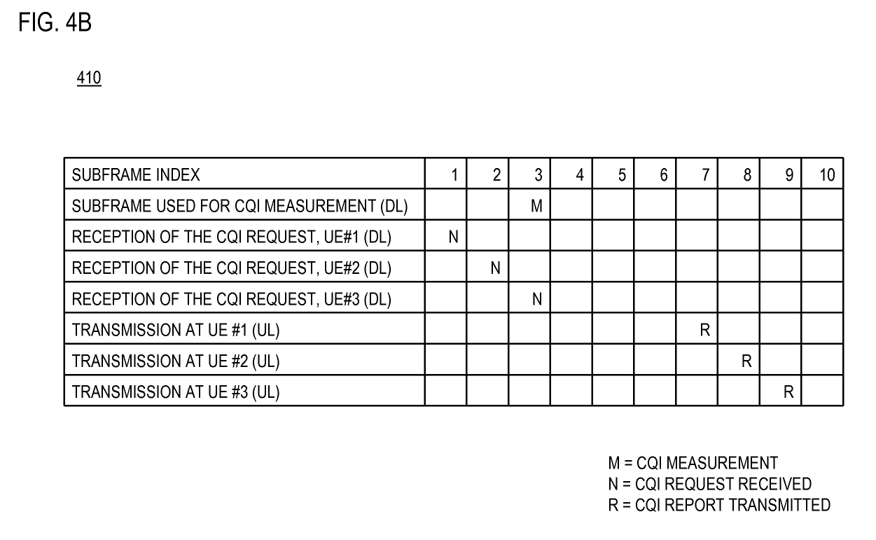

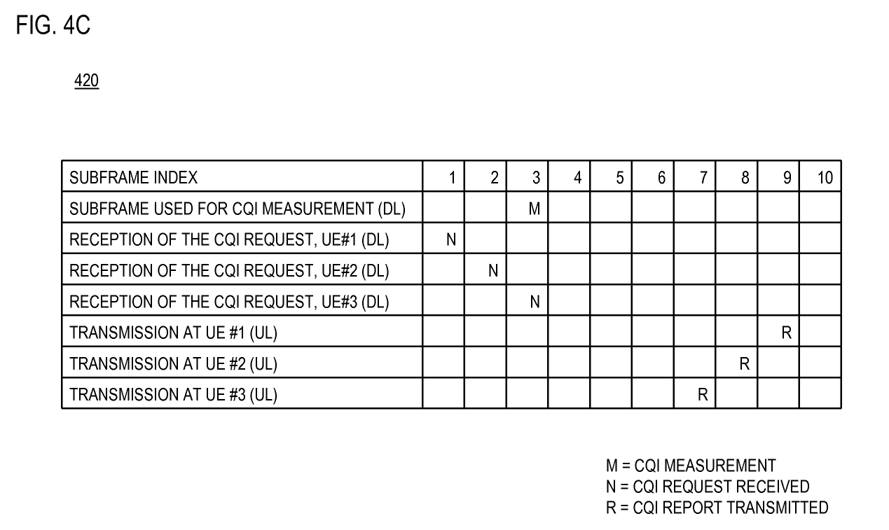

FIGS. 4A-4C are diagrams of optimized timing patterns for an aperiodic channel state reporting scheme, according to various exemplary embodiments. FIG. 4A depicts a diagram of an optimized timing pattern 400 for channel state reporting in which a fixed timing offset is applied from the time of channel state measurement (m) to the time of reporting (n) regardless of when the reporting trigger (n) was received. For example, measurement occurs at subframe 3 for all UEs (such as UE 101) even though UE 1 received a trigger at subframe 1, UE 2 at subframe 2, and UE 3 at subframe 3. Consequently all three UEs transmit their respective channel state reports at the same time (e.g., subframe 7).

FIG. 4B depicts a diagram of an optimized timing pattern wherein the UEs (such as UE 101) are ordered and the first UE is assigned a smallest offset and the last UE is assigned the greatest offset. For example, optimized timing pattern 410 illustrates that UE 1 is scheduled to transmit its channel state report at subframe 7, UE 2 at subframe 8, and UE 3 at subframe 9. FIG. 4C depicts a diagram of an optimized timing pattern wherein the UEs (such as UE 101) are ordered and the first UE is assigned the largest offset and the last UE is assigned the smallest offset. For example, optimized timing pattern 410 illustrates that UE 1 is scheduled to transmit its channel state report at subframe 9, UE 2 at subframe 8, and UE 3 at subframe 9.

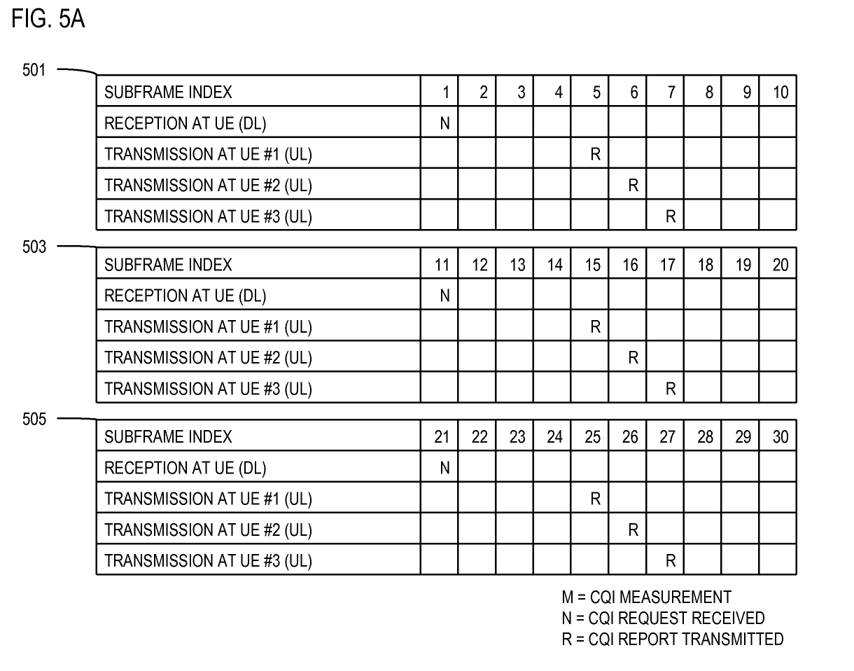

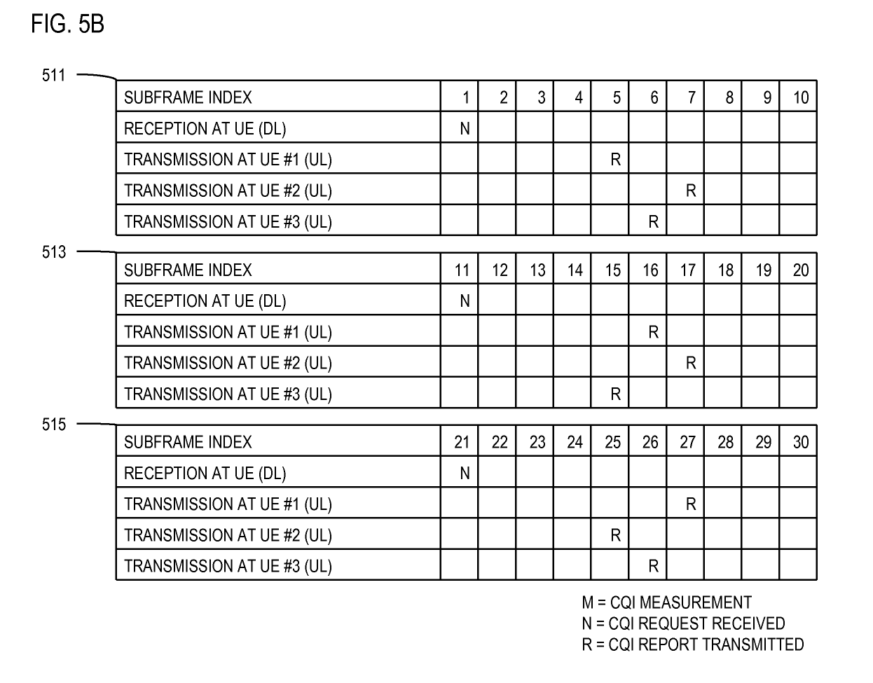

FIGS. 5A and 5B are diagrams of optimized timing patterns for periodic channel state reporting scheme, according to various exemplary embodiments. FIG. 5A depicts a diagram of an optimized timing pattern in which each UE 101 is assigned the constant periodic time offset for transmitting a channel state report for each transmission frame. For example, FIG. 5A depicts three full transmission frames 501, 503, and 505. In each transmission frame, each UE 101 transmits its report at the same relative time (e.g., UE 1 at subframes 5, 15, and 25; UE 2 at subframes 6, 16, and 26; and UE 3 at subframes 7, 17, and 27).

FIG. 5B depicts a diagram of an optimized timing pattern in which each UE 101 is assigned a different offset with each transmission frame. The assignment may change randomly or may change according to some predetermined scheme (i.e., pseudo-random). As shown in transmission frames 511, 513, and 515, UE 1 transmits is report at subframes 5, 16, and 27; UE 2 at subframes 7, 17, and 25; and UE 3 at subframes 6, 5, and 26.

The process for providing channel state reporting scheme can be performed over a variety of networks; an exemplary system is described with respect to FIGS. 6A-6D.

FIGS. 6A-6D are diagrams of communication systems having exemplary long-term evolution (LTE) architectures, in which the user equipment (UE) 101 and the base station 103 of FIG. 1 can operate, according to various exemplary embodiments of the invention. By way of example (shown in FIG. 6A), a base station 103 (e.g., destination node) and a user equipment 101 (UE) (e.g., source node) can communicate in system 600 using any access scheme, such as Time Division Multiple Access (TDMA), Code Division Multiple Access (CDMA), Wideband Code Division Multiple Access (WCDMA), Orthogonal Frequency Division Multiple Access (OFDMA) or Single Carrier Frequency Division Multiple Access (FDMA) (SC-FDMA) or a combination of thereof. In an exemplary embodiment, both uplink and downlink can utilize WCDMA. In another exemplary embodiment, uplink utilizes SC-FDMA, while downlink utilizes OFDMA.

The communication system 600 is compliant with 3GPP LTE, entitled “Long Term Evolution of the 3GPP Radio Technology” (which is incorporated herein by reference in its entirety). As shown in FIG. 6A, one or more user equipment (UEs) 101 communicate with a network equipment, such as a base station 103, which is part of an access network (e.g., WiMAX (Worldwide Interoperability for Microwave Access), 3GPP LTE (or E-UTRAN), etc.). Under the 3GPP LTE architecture, base station 103 is denoted as an enhanced Node B (eNB).

MME (Mobile Management Entity)/Serving Gateways 601 are connected to the eNBs 103 in a full or partial mesh configuration using tunneling over a packet transport network (e.g., Internet Protocol (IP) network) 603. Exemplary functions of the MME/Serving GW 601 include distribution of paging messages to the eNBs 103, termination of U-plane packets for paging reasons, and switching of U-plane for support of UE mobility. Since the GWs 601 serve as a gateway to external networks, e.g., the Internet or private networks 603, the GWs 601 include an Access, Authorization and Accounting system (AAA) 605 to securely determine the identity and privileges of a user and to track each user's activities. Namely, the MME Serving Gateway 601 is the key control-node for the LTE access-network and is responsible for idle mode UE tracking and paging procedure including retransmissions. Also, the MME 601 is involved in the bearer activation/deactivation process and is responsible for selecting the SGW (Serving Gateway) for a UE at the initial attach and at time of intra-LTE handover involving Core Network (CN) node relocation.

A more detailed description of the LTE interface is provided in 3GPP TR 25.813, entitled “E-UTRA and E-UTRAN: Radio Interface Protocol Aspects,” which is incorporated herein by reference in its entirety.

In FIG. 6B, a communication system 602 supports GERAN (GSM/EDGE radio access) 604, and UTRAN 606 based access networks, E-UTRAN 612 and non-3GPP (not shown) based access networks, and is more fully described in TR 23.882, which is incorporated herein by reference in its entirety. A key feature of this system is the separation of the network entity that performs control-plane functionality (MME 608) from the network entity that performs bearer-plane functionality (Serving Gateway 610) with a well defined open interface between them S11. Since E-UTRAN 612 provides higher bandwidths to enable new services as well as to improve existing ones, separation of MME 608 from Serving Gateway 610 implies that Serving Gateway 610 can be based on a platform optimized for signaling transactions. This scheme enables selection of more cost-effective platforms for, as well as independent scaling of, each of these two elements. Service providers can also select optimized topological locations of Serving Gateways 610 within the network independent of the locations of MMEs 608 in order to reduce optimized bandwidth latencies and avoid concentrated points of failure.

As seen in FIG. 6B, the E-UTRAN (e.g., eNB) 612 interfaces with UE 101 via LTE-Uu. The E-UTRAN 612 supports LTE air interface and includes functions for radio resource control (RRC) functionality corresponding to the control plane MME 608. The E-UTRAN 612 also performs a variety of functions including radio resource management, admission control, scheduling, enforcement of negotiated uplink (UL) QoS (Quality of Service), cell information broadcast, ciphering/deciphering of user, compression/decompression of downlink and uplink user plane packet headers and Packet Data Convergence Protocol (PDCP).

The MME 608, as a key control node, is responsible for managing mobility UE identifies and security parameters and paging procedure including retransmissions. The MME 608 is involved in the bearer activation/deactivation process and is also responsible for choosing Serving Gateway 610 for the UE 101. MME 608 functions include Non Access Stratum (NAS) signaling and related security. MME 608 checks the authorization of the UE 101 to camp on the service provider's Public Land Mobile Network (PLMN) and enforces UE 101 roaming restrictions. The MME 608 also provides the control plane function for mobility between LTE and 2G/3G access networks with the S3 interface terminating at the MME 608 from the SGSN (Serving GPRS Support Node) 614.

The SGSN 614 is responsible for the delivery of data packets from and to the mobile stations within its geographical service area. Its tasks include packet routing and transfer, mobility management, logical link management, and authentication and charging functions. The S6a interface enables transfer of subscription and authentication data for authenticating/authorizing user access to the evolved system (AAA interface) between MME 608 and HSS (Home Subscriber Server) 616. The S10 interface between MMEs 608 provides MME relocation and MME 608 to MME 608 information transfer. The Serving Gateway 610 is the node that terminates the interface towards the E-UTRAN 612 via S1-U.

The S1-U interface provides a per bearer user plane tunneling between the E-UTRAN 612 and Serving Gateway 610. It contains support for path switching during handover between eNBs 103. The S4 interface provides the user plane with related control and mobility support between SGSN 614 and the 3GPP Anchor function of Serving Gateway 610.

The S12 is an interface between UTRAN 606 and Serving Gateway 610. Packet Data Network (PDN) Gateway 618 provides connectivity to the UE 101 to external packet data networks by being the point of exit and entry of traffic for the UE 101. The PDN Gateway 618 performs policy enforcement, packet filtering for each user, charging support, lawful interception and packet screening. Another role of the PDN Gateway 618 is to act as the anchor for mobility between 3GPP and non-3GPP technologies such as WiMax and 3GPP2 (CDMA 1X and EvDO (Evolution Data Only)).

The S7 interface provides transfer of QoS policy and charging rules from PCRF (Policy and Charging Role Function) 620 to Policy and Charging Enforcement Function (PCEF) in the PDN Gateway 618. The SGi interface is the interface between the PDN Gateway and the operator's IP services including packet data network 622. Packet data network 622 may be an operator external public or private packet data network or an intra operator packet data network, e.g., for provision of IMS (IP Multimedia Subsystem) services. Rx+ is the interface between the PCRF and the packet data network 622.

As seen in FIG. 6C, the eNB 103 utilizes an E-UTRA (Evolved Universal Terrestrial Radio Access) (user plane, e.g., RLC (Radio Link Control) 615, MAC (Media Access Control) 617, and PHY (Physical) 619, as well as a control plane (e.g., RRC 621)). The eNB 103 also includes the following functions: Inter Cell RRM (Radio Resource Management) 623, Connection Mobility Control 625, RB (Radio Bearer) Control 627, Radio Admission Control 629, eNB Measurement Configuration and Provision 631, and Dynamic Resource Allocation (Scheduler) 633.

The eNB 103 communicates with the aGW 601 (Access Gateway) via an S1 interface. The aGW 601 includes a User Plane 601a and a Control plane 601b. The control plane 601b provides the following components: SAE (System Architecture Evolution) Bearer Control 635 and MM (Mobile Management) Entity 637. The user plane 601b includes a PDCP (Packet Data Convergence Protocol) 639 and a user plane functions 641. It is noted that the functionality of the aGW 601 can also be provided by a combination of a serving gateway (SGW) and a packet data network (PDN) GW. The aGW 601 can also interface with a packet network, such as the Internet 643.

In an alternative embodiment, as shown in FIG. 6D, the PDCP (Packet Data Convergence Protocol) functionality can reside in the eNB 103 rather than the GW 601. Other than this PDCP capability, the eNB functions of FIG. 6C are also provided in this architecture.

In the system of FIG. 6D, a functional split between E-UTRAN and EPC (Evolved Packet Core) is provided. In this example, radio protocol architecture of E-UTRAN is provided for the user plane and the control plane. A more detailed description of the architecture is provided in 3GPP TS 36.300.

The eNB 103 interfaces via the Si to the Serving Gateway 645, which includes a Mobility Anchoring function 647. According to this architecture, the MME (Mobility Management Entity) 649 provides SAE (System Architecture Evolution) Bearer Control 651, Idle State Mobility Handling 653, and NAS (Non-Access Stratum) Security 655.

The processes described herein for providing a channel state reporting scheme may be advantageously implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

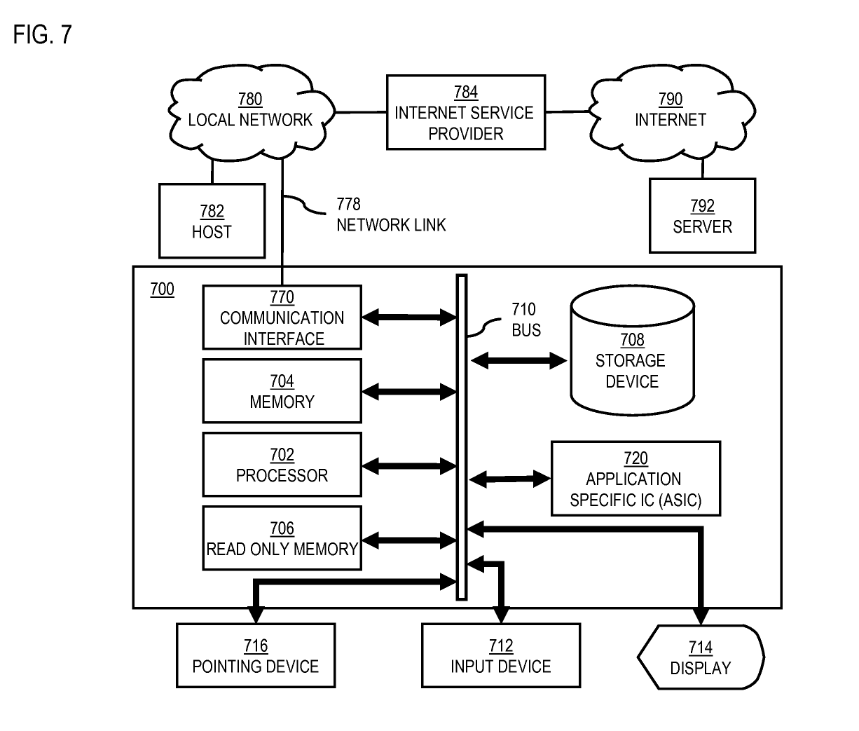

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to carry out the inventive functions described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of optimizing the timing scheme for channel state reporting.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to optimizing the timing scheme for channel state reporting. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for optimizing the timing scheme for channel state reporting. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for optimizing the timing scheme for channel state reporting, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network for optimizing the timing scheme for channel state reporting to the UE 101.

The term “computer-readable medium” as used herein refers to any medium that participates in providing information to processor 702, including instructions for execution. Such a medium may take many forms, including, but not limited to, computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

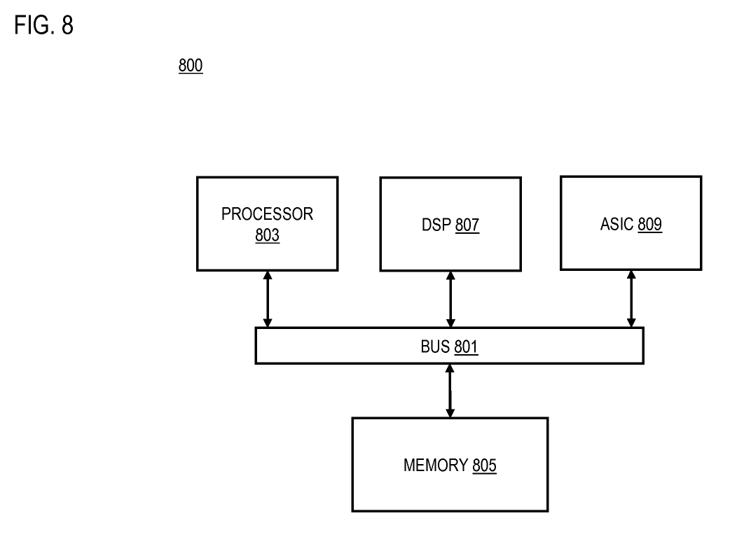

FIG. 8 illustrates a chip set 800 upon which an embodiment of the invention may be implemented. Chip set 800 is programmed to carry out the inventive functions described herein and includes, for instance, the processor and memory components described with respect to FIG. 7 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 800, or a portion thereof, constitutes a means for performing one or more steps of optimizing the timing scheme for channel state reporting.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to optimize the timing scheme for channel state reporting. The memory 805 also stores the data associated with or generated by the execution of the inventive steps.

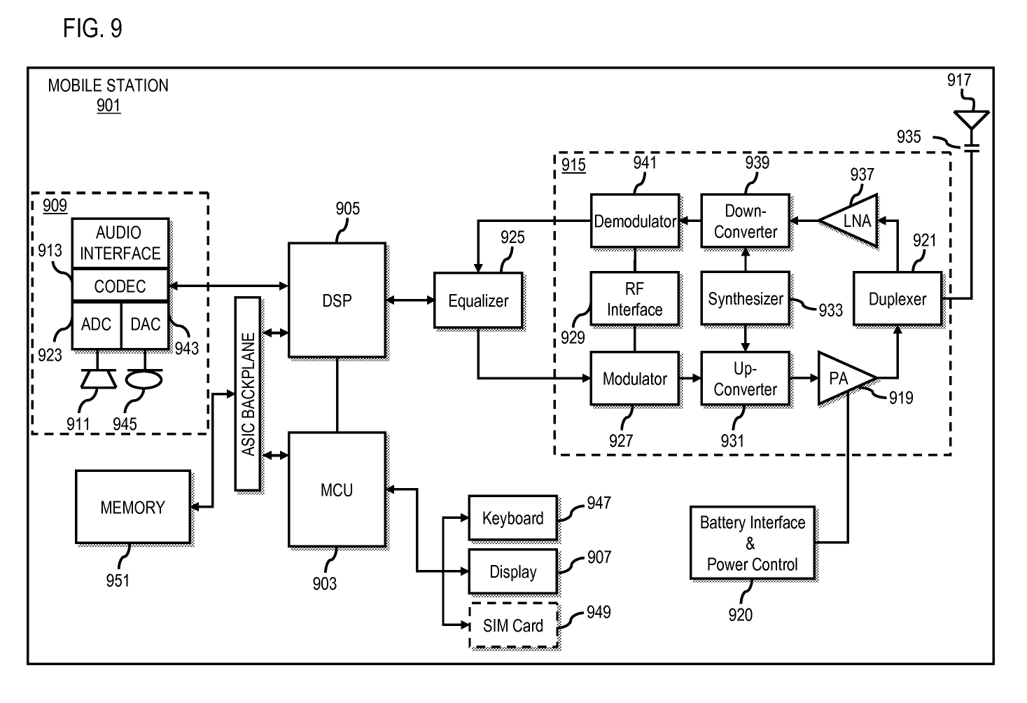

FIG. 9 is a diagram of exemplary components of a mobile station (e.g., handset) capable of operating in the system of FIG. 1, according to one embodiment. In some embodiments, mobile terminal 900, or a portion thereof, constitutes a means for performing one or more steps of optimizing the timing scheme for channel state reporting. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that perform or support the steps of optimizing the timing scheme for channel state reporting. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In the exemplary embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to optimize the timing scheme for channel state reporting. The MCU 903 delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
determining an offset value for each of a plurality of user equipment, wherein the offset values relate to timing between a channel state measurement point and a corresponding point for reporting of the channel state measurement; and
initiating signaling of the offset values to the respective user equipment.

2. A method of claim 1, wherein the offset values are set based on fixed timing offset values, a predetermined pattern, a system frame number, or a combination thereof.

3. A method according to claim 1, wherein the offset values are signaled with reporting related parameters over a radio resource control channel or are signaled implicitly using one or a user equipment identifier, resource index, or resource block allocation information.

4. A method according to claim 1, further comprising:
causing, at least in part, coordination of a triggering and receipt of the plurality of measurement reports with one or more base stations.

5. A method according to claim 1, wherein the channel state measurement includes measurement of a channel quality indicator (CQI), precoding matrix indicator (PMI), ranking indicator (RI), channel frequency response, channel impulse response, or any combination thereof, and wherein channel measurement reports are multiplexed onto a control channel that includes at least one of a physical uplink shared channel or a physical uplink control channel.

6. An apparatus comprising:
at least one processor; and
at least one memory including computer program code,
the at least one memory and the computer program code configured to, with the at least one processor, cause the apparatus to perform at least the following,
determine an offset value for each of a plurality of user equipment, wherein the offset values relate to timing between a channel state measurement point and a corresponding point for reporting of the channel state measurement; and
initiate signaling of the offset values to the respective user equipment.

7. An apparatus of claim 6, wherein the offset values are set based on fixed timing offset values, a predetermined pattern, a system frame number, or a combination thereof.

8. An apparatus according to claim 6, wherein the offset values are signaled with reporting related parameters over a radio resource control channel or are signaled implicitly using one or a user equipment identifier, resource index, or resource block allocation information.

9. An apparatus according to claim 6, wherein the apparatus is further caused to:
cause, at least in part, coordination of a triggering and receipt of the plurality of measurement reports with one or more base stations.

10. An apparatus according to claim 6, wherein the channel state measurement includes measurement of a channel quality indicator (CQI), precoding matrix indicator (PMI), ranking indicator (RI), channel frequency response, channel impulse response, or any combination thereof.

11. A method comprising:
receiving an offset value that relates to timing between a channel state measurement point and a corresponding point for reporting of the channel state measurement;
initiating a measurement procedure for determining channel state parameters; and
generating a measurement report, specifying the channel state parameters, for transmission to one or more base stations over different subframes of a common transmission frame.

12. A method of claim 11, wherein the offset value is set based on a fixed timing offset value, a predetermined pattern, a system frame number, or a combination thereof.

13. A method according to claim 11, wherein the offset value is received with reporting related parameters over a radio resource control channel or is received implicitly using one of a user equipment identifier, resource index, or resource block allocation information.

14. A method according to claim 11, further comprising:
causing, at least in part, coordination of the transmission of the measurement report with one or more user equipment.

15. A method according to claim 11, wherein the channel state measurement includes measurement of a channel quality indicator (CQI), precoding matrix indicator (PMI), ranking indicator (RI), channel frequency response, channel impulse response, or any combination thereof, and wherein channel measurement reports are multiplexed onto a control channel that includes at least one of a physical uplink shared channel or a physical uplink control channel.

16. An apparatus comprising:
at least one processor; and
at least one memory including computer program code,
the at least one memory and the computer program code configured to, with the at least one processor, cause the apparatus to perform at least the following,
receive an offset value that relates to timing between a channel state measurement point and a corresponding point for reporting of the channel state measurement;
initiate a measurement procedure for determining channel state parameters; and
generate a measurement report, specifying the channel state parameters, for transmission to one or more base stations over different subframes of a common transmission frame.

17. An apparatus of claim 16, wherein the offset value is set based on a fixed timing offset value, a predetermined pattern, a system frame number, or a combination thereof.

18. An apparatus according to claim 16, wherein the offset value is received with reporting related parameters over a radio resource control channel or is received implicitly using one of a user equipment identifier, resource index, or resource block allocation information.

19. An apparatus according to claim 16, wherein the apparatus is further caused to perform:
causing, at least in part, coordination of the transmission of the measurement report with one or more user equipment.

20. An apparatus according to claim 16, wherein the channel state measurement includes measurement of a channel quality indicator (CQI), precoding matrix indicator (PMI), ranking indicator (RI), channel frequency response, channel impulse response, or any combination thereof.
